(19) United States
(12) Patent Application Publication
(10) Pub. No.: US 2011/0183031 A1
(43) Pub. Date: Jul. 28, 2011

(54) RANGE OF SHELF STABLE INFANT FOODS WHICH INCLUDE ONLY NATURALLY CONTAINED SUGARS AND METHODS FOR MAKING THE SAME

(76) Inventor: Silja Ursel, Konstanz (DE)

(21) Appl. No.: 12/672,909

(22) PCT Filed: Sep. 5, 2008
(86) PCT No.: PCT/EP2008/007260

§ 371 Date: Jul. 13, 2010

(30) Foreign Application Priority Data
Sep. 7, 2007 (EP) 07017566.6

(51) Int. Cl. A23L 1/29; A23L 1/212

(52) U.S. Cl. 426/2; 426/658; 426/639; 426/615; 426/648

(57) ABSTRACT

A range of infant food products comprises a plurality of products wherein each product in the range has less than about 10% total energy of the product provided by added sugar. The resulting range of infant food products has the advantage that each food product in the range has a natural taste which results from the components in the product rather than a sweet taste provided by added sugar.

### BACKGROUND OF THE INVENTION

1. Field of the Invention

The present invention relates generally to infant food products and particularly to infant food products having no sugar and no sweetening fruit juice concentrates added during processing or packaging.

2. Description of Related Art

Exclusive breastfeeding during the first six months of life is considered the best way of providing ideal nutrition for healthy growth and development of infants. Breastfeeding also strengthens an infant's immune system, reducing the incidence and severity of infectious diseases.

Some mothers cannot breastfeed, while others, for personal, cultural, socio-economic or health reasons, choose not to. In these cases, the World Health Organisation (WHO) states that mothers should be supported in optimising their infant's nutrition.

### Infant Formula

The WHO/Food and Agricultural Organisation of the United Nations (FAO) Codex Alimentarius Commission, the UN body that sets international standards for foods, recognises that infant formula is the best substitute for breast milk. While industrially prepared infant formula cannot replicate exactly all the qualities of breast milk, it represents a considerable improvement over traditional substitutes that may be nutritionally inadequate and unsafe. These include unmodified animal milk (from cows, goats or buffaloes) and various types of cereal gruel.

Industrially prepared infant formula has been designed for use from birth as a partial or total replacement for breast milk. The Codex Alimentarius defines it as “a product based on milk of cows or other animals and/or other edible constituents of animal, including fish, or plant origin, which have proved to be suitable for infant feeding.” When used as the sole source of nourishment, infant formula must meet all the energy and nutrient requirements of infants during the first six months of life.

### Complementary Foods

After an initial six months of exclusive breastfeeding, infants should start receiving nutritionally adequate, safe and appropriate complementary foods.

Complementary foods are used for weaning and they can be defined as “any food, whether manufactured or locally prepared, suitable as a complement to breast milk or to infant formula, when either becomes insufficient to satisfy the nutritional requirements of the infant.” They include, for example, milk products, home made foods and processed foods (cereal-based or other baby foods, including ready-to-eat preparations).

Complementary foods should be introduced into an infant's diet when breast-milk or a breast-milk substitute no longer satisfies the infant's nutritional requirements. During this transition period, as the infant's digestive system develops, the infant's diet can gradually evolve from an exclusive milk diet to a fully diversified diet similar to that of adults.

Different tastes and textures can be progressively introduced into the diet, for example through cereals mixed with the baby's usual milk or puréed fruit and vegetables. Later, increasingly solid foods can be added.

Many mothers, especially those in rural areas of developing countries, prepare complementary foods at home. It is highly unlikely, however, that these foods will supply all the calories, iron and other micronutrients needed by infants aged 6-24 months. In light of this, food manufacturers have developed calorie-dense complementary foods enriched with micronutrients to meet these requirements. They include protein, carbohydrate and fat in varying amounts. The carbohydrate component includes starch and complex fibres which are not digestible by the infant and therefore have no impact on blood sugar levels and sugars.

Conventionally, extrinsic sugars such as sucrose and fructose, have been added to food products to give the products a sweet taste. This increases the likelihood that infants will enjoy eating the food products and helps to ensure that they will have a sufficient food intake for growth and development.

However, it has been found that children can develop a limited taste palette because they can become conditioned to sweet tasting foods. In addition, there has been an increased incidence of dental and weight problems including obesity, because children eat larger amounts of sweet foods.

Furthermore, it has been found that one-off food products that are available will not provide a complete diet for an infant because if an infant is repetitively fed food which has the same or similar tastes, they become bored with the taste and eat less.

In addition, foods having differing nutritional components are required as an infant develops. In this regard, stages of infant development can be defined, wherein Stage 1 refers to about 4 to about 6 months of age; Stage 2 refers to about 6 to about 8 months of age, Stage 3 refers to about 8 to about 12 months of age, and Stage 4 (also referred to as Junior Stage) refers to about 12 to about 36 months of age. Infants falling within these different developmental stages have different nutritional requirements. Thus, there is a need for a new range of food products that have natural tastes and methods for making such products.

### SUMMARY OF THE INVENTION

It is, therefore, an object of the invention to provide a new range of infant food products that provide a variety of tastes.

It is a further object of the invention to provide a new range of infant food products that does not lead to development weight problems including obesity.

These and other objects are addressed in one aspect of the invention by providing a range of infant food products wherein each product in the range has less than about 10% total energy of the product provided by added sugar. The resulting range of infant food products has the advantage that each food product in the range has a natural taste which results from the components in the product rather than a sweet taste provided by added sugar. In various embodiments, the components include substantially no added sugar (eg less than 1% total energy of the product provided by added sugar) or no added sugar so that the product has only naturally occurring sugars that are intrinsically present in the components of the food product.

Advantageously, a range of food products according to the invention does not condition developing infants to sweet tasting foods and there is a reduced likelihood of developing obesity.

In a further aspect, the invention provides a feeding regime for meeting the nutritional needs of an infant during different stages of development, the regime comprising administering to an infant a range of food products according to the invention.

In a further aspect, the invention provides use of a range of food products according to the invention in the manufacture of one or more medicaments for the prevention or treatment of a nutritionally related disorder.

In another aspect, the invention provides a method of preventing or treating a nutritionally related disorder, comprising administering a range of food products according to the invention.

The nutritionally related disease is optionally selected from obesity, malnutrition, diabetes and heart disease.

These and further objects, features, and advantages of the present invention will be readily apparent to those skilled in the art.

### BRIEF DESCRIPTION OF THE DRAWINGS

FIG. 1 illustrates a feeding plan according to the invention.

### DETAILED DESCRIPTION OF THE INVENTION

### Definitions

Within the context of this specification, the term “about” means plus or minus 20%, more preferably plus or minus 10%, even more preferably plus or minus 5%, most preferably plus or minus 2%.

The term “range of infant food products” refers to a plurality of packaged nutritional compositions (eg 2 or more) that, together with milk, provide the nutritional requirements an infant. The range could be interpreted to form a kit of parts.

The term “sugar” refers to refers to a monosaccharide or disaccharide.

The term “added sugar” refers to extrinsic sugars that are typically added to food products during processing merely for sweetening purposes. These extrinsic sugars include refined sucrose, fructose, glucose syrup, honey, and sugars derived from sweet fruit juice concentrates (eg juice from apple, pear, grape and banana).

The invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All patents, patent applications, and publications mentioned herein are incorporated herein by reference to the extent allowed by law for the purpose of describing and disclosing the compounds and methodologies reported therein that might be used with the present invention. However, nothing herein is to be construed as an admission that the invention is not entitled to antedate such disclosure by virtue of prior invention.

All percentages for weights expressed herein are by weight of the total food product unless specifically stated otherwise.

Within this specification embodiments have been described in a way which enables a clear and concise specification to be written, but it is intended and will be appreciated that embodiments may be variously combined or separated without parting from the invention

### The Invention

In one aspect, the invention provides a range of infant food products wherein each product in the range has less than about 10% total energy of the product provided by added sugar. The resulting range of infant food products has the advantage that each food product in the range has a natural taste which results from the components in the product rather than a sweet taste provided by added sugar.

In a preferred embodiment each product in the range comprises less than about 5% total energy of the product provided by added sugar. More preferably, each product in the range comprises less than about 2% total energy of the product provided by added sugar.

In a preferred embodiment, the components include substantially no added sugar (eg less than 1% total energy of the product provided by added sugar) or no added sugar so that the product has only naturally occurring sugars that are intrinsically present in the components of the food product.

Preferably, the range of products comprises at least one food product suitable for each stage of infant development.

Preferably, the range of products comprises two or more food products suitable for each stage of infant development. More preferably, the range of products comprises at least a vegetable based product and a fruit based product for each stage of infant development. More preferably, the range of products comprises a plurality of vegetable based products and fruit based products for each stage of infant development.

Preferably, the range of products comprises at least a vegetable based product and a fruit based product for stage 1 of infant development.

Preferably, the range of products comprises at least a vegetable based product, a complete meal and a fruit based product for stage 2 of infant development. A complete meal is designed to provide one nutritionally balanced serving—it is not necessary to combine the complete meal with another food product to provide a meal.

Preferably, the range of products comprises at least a vegetable based product, a complete meal and a fruit based product for stage 3 of infant development.

Preferably, the range of products comprises at least a vegetable based product, a complete meal and a fruit based product for stage 4 of infant development.

Preferably, the infant food products for infants from about 4 to about 6 months of age (Stage 1) comprise one or more vegetables selected from artichoke, carrot, cucumber, fennel, French bean, leek, lettuce, parsnip, pea, potato, pumpkin, spinach, squash and zucchini.

Preferably, infant food products for infants from about 4 to about 6 months of age (Stage 1) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant and watermelon.

Preferably, infant food products for infants from about 4 to about 6 months of age (Stage 1) comprise one or more aromatic herbs and spices selected from anise, balm mint, chamomile, caraway, gherkin, orange blossom and sorrel.

Preferably, infant food products for infants from about 6 to about 8 months of age (Stage 2) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea and spinach.

Preferably, infant food products for infants from about 6 to about 8 months of age (Stage 2) comprise one or more legumes selected from soy, black gram seed, chickpea, cowpea, kidney bean, lentil, mung bean and pigeon pea.

In another embodiment, infant food products for infants from about 6 to about 8 months of age (Stage 2) comprise one or more meats selected from of beef, veal, chicken, lamb, pork, turkey and duck, and/or fish.

Preferably, infant food products for infants from about 6 to about 8 months of age (Stage 2) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry and tangerine.

Preferably, infant food products for infants from about 6 to about 8 months of age (Stage 2) comprise one or more aromatic herbs and spices selected from anise, balm mint, chamomile, caraway, gherkin, orange blossom, sorrel, cardamom, chives, cumin, onion, saffron, savory, shallot and thyme.

Preferably, infant food products for infants from about 6 to about 8 months of age (Stage 2) comprise coconut.

Preferably, infant food products for infants from about 8 to about 12 months of age (Stage 3) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea, spinach, asparagus, beet (root), brussel sprout, cabbage, garden pea, radish and turnip.

Preferably, infant food products for infants from about 8 to about 12 months of age (Stage 3) comprise one or more legumes selected from soy, black gram seed, chickpea, cowpea, kidney bean, lentil, mung bean, pigeon pea, lima bean and winged bean.

Preferably, infant food products for infants from about 8 to about 12 months of age (Stage 3) comprise one or more meats selected from beef, veal, chicken, lamb, pork, turkey and duck, and/or fish and/or eggs.

Preferably, infant food products for infants from about 8 to about 12 months of age (Stage 3) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry, tangerine and rhubarb.

Preferably, infant food products for infants from about 8 to about 12 months of age (Stage 3) comprise one or more aromatic herbs and spices selected from anise, balm mint, chamomile, caraway, gherkin, orange blossom, sorrel, cardamom, chives, cumin, onion, saffron, savory, shallot, thyme, coriander, curcuma, garden sorrel, garlic, mint and vanilla.

Preferably, infant food products for infants from about 8 to about 12 months of age (Stage 3) comprise coconut and/or cocoa.

Preferably, it is preferred that infant food products for infants from about 12 to about 36 months of age (Stage Junior) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea, spinach, asparagus, beet (root), brussel sprout, cabbage, garden pea, radish, turnip, mushroom and watercress.

Preferably, infant food products for infants from about 12 to about 36 months of age (Stage Junior) comprise one or more legumes selected from soy, black gram seed, chickpea, cowpea, kidney bean, lentil, mung bean, pigeon pea, lima bean and winged bean.

Preferably, infant food products for infants from about 12 to about 36 months of age (Stage Junior) comprise one or more meats selected from beef, veal, chicken, lamb, pork, turkey, duck, and/or fish, and/or eggs and/or crustaceans.

Preferably, infant food products for infants from about 12 to about 36 months of age (Stage Junior) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry, tangerine, rhubarb, grapefruit and kiwi.

Preferably, infant food products for infants from about 12 to about 36 months of age (Stage Junior) comprise one or more aromatic herbs and spices selected from anise, balm mint, chamomile, caraway, gherkin, orange blossom, sorrel, cardamom, chives, cumin, onion, saffron, savory, shallot, thyme, coriander, curcuma, garden sorrel, garlic, mint, vanilla, basil, bay laurel, chervil, cinnamon, clove, ginger, liquorice, mace, marjoram, nutmeg, oregano, parsley, pepper, rosemary, sage and terragon.

Preferably, infant food products for infants from about 12 to about 36 months of age (Stage Junior) comprise one or more nuts selected from coconut, cocoa, almond, beechnut, brazil nut, cashew nut, chestnut, hazelnut, macadamia nut, pecan nut, pistachio nut and walnut.

In a further aspect, the invention provides a feeding regime for meeting the nutritional needs of an infant during different stages of development, the regime comprising administering to an infant a range of food products according to the invention.

In a further aspect, the invention provides use of a range of food products according to the invention in the manufacture of one or more medicaments for the prevention or treatment of a nutritionally related disorder.

In another aspect, the invention provides a method of preventing or treating a nutritionally related disorder, comprising administering a range of food products according to the invention.

The nutritionally related disease is optionally selected from obesity, malnutrition, diabetes and heart disease.

In other aspects, the invention provides the product produced using the method of the invention and the product produced using the apparatus of the invention.

### EXAMPLES

This invention can be further illustrated by the following examples although it will be understood that these examples are included merely for purposes of illustration and are not intended to limit the scope of the invention unless otherwise specifically indicated.

A daily complementary diet for stage 1 comprised:
(i) 100 g portion of infant cereal;
(ii) 65 g portion of vegetable dish in accordance with the invention; and
(iii) 65 g portion of fruit dish in accordance with the invention.

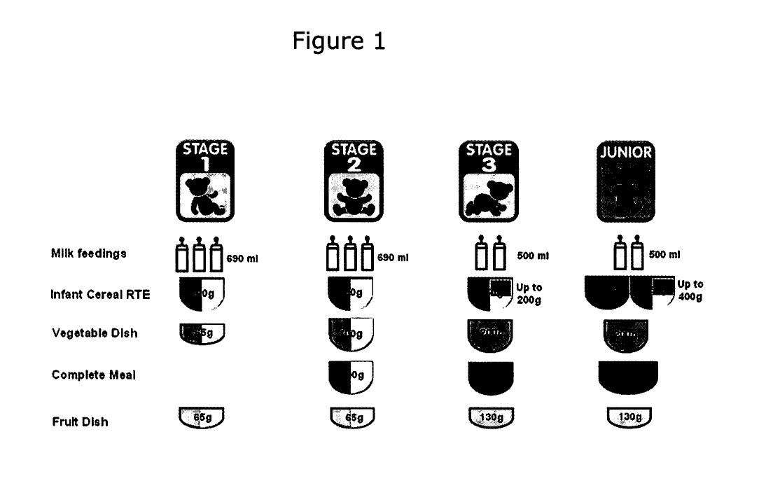

A number of vegetable and fruit dishes were provided in a range of baby food products and were labeled according to their suitability for a stage 1 diet. The feeding plan shown in FIG. 1 was used to determine which meals could make up the daily food intake for stage 1. In this example, the vegetable dish was a pumpkin based dish and the fruit dish was an apple based dish.

TABLE 1
List of ingredients for vegetable dish

| | Amount per |
|---|---|
| Ingredient | 100 g (g) |
| POTATO FLAKES | 4.000 |
| Pumpkin frozen | 40.000 |
| Potato 6 × 6 mm frozen | 10.000 |
| CARROT | 15.000 |
| RAPESEED OIL LOW ERUCIC (CANOLA) | 0.400 |
| SUNFLOWER OIL | 0.400 |
| WATER | 30.200 |

TABLE 2
List of ingredients for fruit dish

| | Amount per |
|---|---|
| Ingredient | 100 g (g) |
| Apple fresh | 99.95 |
| Vitamin C | 0.05 |

Each dish provided the following nutritional values:

TABLE 3
Nutritional values provided by each Stage 1 dish

| | | | % daily |
|---|---|---|---|
| | kcal/100 g | kcal/serving | energy intake |
| Cereal Dish | 106.0 for | 106.00 | 17.0 |
| | RTE pap | | |
| | 424 for | | |
| | dry | | |
| | powder | | |
| Vegetable Dish | 40.7 | 26.46 | 4.2 |
| Fruit Dish | 53.2 | 34.58 | 5.5 |

The total daily nutritional values provided by the complementary dishes were as follows:

TABLE 4
Daily nutritional values provided
by the Stage 1 complementary dishes

| | | | E % (daily |
|---|---|---|---|
| | per day | per 100 g | energy intake) |
| Total Protein (g) | 4.3 | 2.8 | 10.4 |
| Total Fat (g) | 3.3 | 2.2 | 18.1 |
| Total CHO (g) | 29.8 | 19.2 | 71.5 |
| Fibres (g) | 3.1 | 2.0 | — |
| Sodium (mg) | 38.1 | 24.6 | — |
| LA (g) | 0.8 | 0.5 | 4.3 |
| ALA (g) | 0.1 | 0.1 | 0.6 |
| LA/ALA ratio | 7.1 | — | — |
| Energy (kcal) | 166.5 | 107.4 | — |

(Wherein CHO represents carbohydrate, LA represents linoleic acid and ALA represents alpha-linolenic acid).

The sum of the daily energy intake provided by the complementary foods was 26.6% (166.5 kcal). The remaining 73.4% (458 kcal) of daily energy intake was provided by milk. This provided a total daily energy intake of 625.04 kcal.

### Example 2

A daily complementary diet for stage 2 comprised:
(i) 100 g portion of infant cereal;
(ii) 100 g portion of vegetable dish in accordance with the invention;
(iii) 100 g portion of a complete meal in accordance with the invention; and
(iv) 65 g portion of fruit dish in accordance with the invention.

A number of complete meals, vegetable and fruit dishes were provided in the range of baby food products and were labeled according to their suitability for a stage 2 diet. The feeding plan shown in FIG. 1 was used to determine which meals could make up the daily food intake for stage 2. In this example, the vegetable dish was garden vegetables and corn based, the complete meal was garden vegetables and lamb based and the fruit dish was apple and raspberry based.

TABLE 5
List of ingredients for vegetable dish

| | Amount per |
|---|---|
| Ingredient | 100 g (g) |
| CARROT | 30.000 |
| POTATO FLAKES | 3.000 |
| Sweetcorn frozen | 10.000 |
| Parsnip frozen | 10.000 |
| RICE SEMOLINA | 1.000 |
| RAPESEED OIL LOW ERUCIC (CANOLA) | 0.400 |
| Fennel frozen | 5.000 |
| SUNFLOWER OIL | 0.200 |
| WATER | 40.400 |

TABLE 6
List of ingredients for complete meal

| | Amount per |
|---|---|
| Ingredient | 100 g (g) |
| POTATO FLAKES | 4.000 |
| CARROT | 30.000 |
| Lamb frozen | 8.500 |
| RICE SEMOLINA | 2.000 |
| Parsnip frozen | 5.000 |
| Sweetcorn frozen | 3.000 |
| RAPESEED OIL LOW ERUCIC (CANOLA) | 0.600 |
| SUNFLOWER OIL | 0.400 |
| Onion 10 mm frozen | 4.000 |
| WATER | 42.500 |

TABLE 7
List of ingredients for fruit dish

| | Amount per |
|---|---|
| Ingredient | 100 g (g) |
| Apple fresh | 79.96 |
| Raspberry puree | 19.99 |
| Vitamin C | 0.05 |

Each dish provided the following nutritional values:

TABLE 8
Nutritional values provided by each Stage 2 dish

| | | | % daily |
|---|---|---|---|
| | kcal/100 g | kcal/serving | energy intake |
| Cereal Dish | 106.0 for | 106.00 | 15.8 |
| | RTE pap | | |
| | 424 for | | |
| | dry | | |
| | powder | | |
| Vegetable Dish | 42.6 | 42.6 | 6.4 |
| Complete Meal | 62.6 | 62.6 | 9.3 |
| Fruit Dish | 50.2 | 32.63 | 4.9 |

The total daily nutritional values provided by the complementary dishes were as follows:

TABLE 9
Daily nutritional values provided
by the Stage 2 complementary dishes

| | | | E % (daily |
|---|---|---|---|
| | per day | per 100 g | energy intake) |
| Total Protein (g) | 7.8 | 2.7 | 12.9 |
| Total Fat (g) | 6.2 | 2.1 | 23.1 |
| Total CHO (g) | 38.5 | 13.3 | 63.9 |
| Fibres (g) | 5.2 | 1.8 | — |
| Sodium (mg) | 75.7 | 26.1 | — |
| LA (g) | 1.2 | 0.4 | 4.6 |
| ALA (g) | 0.2 | 0.1 | 0.6 |
| LA/ALA ratio | 7.3 | — | — |
| Energy (kcal) | 241.1 | 83.1 | — |

The sum of the daily energy intake provided by the complementary foods was 35.9% (241.1 kcal). The remaining 64.1% (428.93 kcal) of daily energy intake was provided by milk. This provided a total daily energy intake of 670.03 kcal.

### Example 3

A daily complementary diet for stage 3 comprised:
(i) 150 g portion of infant cereal;
(ii) 200 g portion of vegetable dish in accordance with the invention;
(iii) 200 g portion of a complete meal in accordance with the invention; and
(iv) 130 g portion of fruit dish in accordance with the invention.

A number of complete meal, vegetable and fruit dishes were provided in the range of baby food products and were labeled according to their suitability for a stage 3 diet. The feeding plan shown in FIG. 1 was used to determine which meals could make up the daily food intake for stage 3. In this example, vegetable dish was garden vegetables and corn based, the complete meal was a pasta, tomato and beef based and the fruit dish was fruit salad based.

TABLE 10
List of ingredients for vegetable dish

| | Amount per |
|---|---|
| Ingredient | 100 g (g) |
| CARROT | 30.000 |
| POTATO FLAKES | 3.000 |
| Sweetcorn frozen | 10.000 |
| Parsnip frozen | 10.000 |
| RICE SEMOLINA | 1.000 |
| RAPESEED OIL LOW ERUCIC (CANOLA) | 0.400 |
| Fennel frozen | 5.000 |
| SUNFLOWER OIL | 0.200 |
| WATER | 40.400 |

TABLE 11
List of ingredients for complete meal

| | Amount per |
|---|---|
| Ingredient | 100 g (g) |
| Pasta spaghetti short | 8.000 |
| Beef frozen 14% fat | 8.000 |
| CARROT | 20.000 |
| Tomato puree | 5.000 |
| RAPESEED OIL LOW ERUCIC (CANOLA) | 0.800 |
| SUNFLOWER OIL | 0.400 |
| Bell pepper red 10 mm frozen | 4.000 |
| Onion 10 mm frozen | 3.000 |
| Thyme frozen | 0.100 |
| WATER | 50.700 |

TABLE 12
List of ingredients for fruit dish

| | Amount per |
|---|---|
| Ingredient | 100 g (g) |
| Apple fresh | 39.98 |
| Pear William fresh | 14.9925 |
| Peach puree | 14.9925 |
| Banana puree without seeds | 19.990 |
| Apricot puree | 9.995 |
| Vitamin C | 0.05 |

Each dish provided the following nutritional values:

TABLE 13
Nutritional values provided by each Stage 3 dish

| | | | % daily |
|---|---|---|---|
| | Kcal/100 g | kcal/serving | energy intake |
| Cereal Dish | 106.0 | 159.00 | 20.6 |
| Vegetable Dish | 42.6 | 85.2 | 11.1 |
| Complete Meal | 65.9 | 131.8 | 17.1 |
| Fruit Dish | 56.0 | 72.8 | 9.5 |

The total daily nutritional values provided by the complementary dishes were as follows:

TABLE 14
Daily nutritional values provided
by the Stage 3 complementary dishes

| | Per day | per 100 g | E % |
|---|---|---|---|
| Total Protein (g) | 14.8 | 2.6 | 13.2 |
| Total Fat (g) | 10.9 | 1.9 | 22 |
| Total CHO (g) | 72.4 | 12.8 | 64.8 |
| Fibres (g) | 8.4 | 1.5 | — |
| Sodium (mg) | 142.3 | 25.1 | — |
| LA (g) | 2.3 | 0.4 | 4.6 |
| ALA (g) | 0.4 | 0.1 | 0.7 |
| LA/ALA ratio | 6.5 | — | — |
| Energy (kcal) | 447.0 | 78.8 | — |

The sum of the daily energy intake provided by the complementary foods was 58.0% (447.0 kcal). The remaining 42.0% (323.0 kcal) of daily energy intake was provided by milk. This provided a total daily energy intake of 770 kcal.

### Example 4

A daily complementary diet for stage 4 comprised:
(i) 350 g portion of infant cereal;
(ii) 200 g portion of vegetable dish in accordance with the invention;
(iii) 250 g portion of a complete meal in accordance with the invention; and
(iv) 130 g portion of fruit dish in accordance with the invention.

A number of complete meals, vegetable and fruit dishes were provided in the range of baby food products and were labeled according to their suitability for a stage 4 diet. The feeding plan shown in FIG. 1 was used to determine which meals could make up the daily food intake for stage 4. In this example, the vegetable dish was a garden vegetables and corn dish, the complete meal was a pasta, tomato and beef dish and the fruit dish was a fruit salad dish.

TABLE 15
List of ingredients for vegetable dish

| | Amount per |
|---|---|
| Ingredient | 100 g (g) |
| CARROT | 30.000 |
| POTATO FLAKES | 3.000 |
| Sweetcorn frozen | 10.000 |
| Parsnip frozen | 10.000 |
| RICE SEMOLINA | 1.000 |
| RAPESEED OIL LOW ERUCIC (CANOLA) | 0.400 |
| Fennel frozen | 5.000 |
| SUNFLOWER OIL | 0.200 |
| WATER | 40.400 |

TABLE 16
List of ingredients for complete meal

| | Amount per |
|---|---|
| Ingredient | 100 g (g) |
| Pasta spaghetti short | 8.000 |
| Beef frozen 14% fat | 8.000 |
| CARROT | 20.000 |
| Tomato puree | 5.000 |
| RAPESEED OIL LOW ERUCIC (CANOLA) | 0.800 |
| SUNFLOWER OIL | 0.400 |
| Bell pepper red 10 mm frozen | 4.000 |
| Onion 10 mm frozen | 3.000 |
| Thyme frozen | 0.100 |
| WATER | 50.700 |

TABLE 17
List of ingredients for fruit dish

| | Amount per |
|---|---|
| Ingredient | 100 g (g) |
| Apple fresh | 39.98 |
| Pear William fresh | 14.9925 |
| Peach puree | 14.9925 |
| Banana puree without seeds | 19.990 |
| Apricot puree | 9.995 |
| Vitamin C | 0.05 |

Each dish provided the following nutritional values:

TABLE 18
Nutritional values provided by each Stage 4 dish

| | | | % daily |
|---|---|---|---|
| | kcal/100 g | kcal/serving | energy intake |
| Cereal Dish | 106.0 | 371 | 35.7 |
| Vegetable Dish | 42.6 | 85.2 | 8.2 |
| Complete Meal | 65.9 | 164.75 | 15.8 |
| Fruit Dish | 56.0 | 72.8 | 7.0 |

The daily nutritional values provided by the complementary dishes were as follows:

TABLE 19
Daily nutritional values provided
by the Stage 4 complementary dishes

| | per day | per 100 g | E % |
|---|---|---|---|
| Total Protein (g) | 23.6 | 3.5 | 13.6 |
| Total Fat (g) | 17.2 | 2.6 | 22.4 |
| Total CHO (g) | 110.6 | 16.6 | 64.0 |
| Fibres (g) | 9.8 | 1.5 | — |
| Sodium (mg) | 215.0 | 32.2 | — |
| LA (g) | 3.4 | 0.5 | 4.5 |
| ALA (g) | 0.5 | 0.1 | 0.7 |
| LA/ALA ratio | 6.8 | — | — |
| Energy (kcal) | 691.7 | 103.6 | — |

The sum of the daily energy intake provided by the complementary foods was 66.5% (691.7 kcal). The remaining 33.5% (348.3 kcal) of daily energy intake was provided by milk. This provided a total daily energy intake of 1040 kcal.

In the specification, there have been disclosed typical preferred embodiments of the invention and, although specific terms are employed, they are used in a generic and descriptive sense only and not for purposes of limitation, the scope of the invention being set forth in the following claims. Obviously many modifications and variations of the present invention are possible in light of the above teachings. It is therefore to be understood that within the scope of the appended claims the invention may be practiced otherwise than as specifically described.

What is claimed is:

1. A range of infant food products wherein each product in the range includes less than about 10% total energy of the product provided by added sugar.

2. A range of infant food products according to claim 1 wherein each product in the range comprises less than about 5% total energy of the product provided by added sugar.

3. A range of infant food products according to claim 1 or 2 wherein each product in the range comprises less than about 2% total energy of the product provided by added sugar.

4. A range of infant food products according to any preceding claim wherein each product in the range comprises substantially no added sugar so that the product has only naturally occurring sugars that are intrinsically present in the components of the food product.

5. A range of infant food products according to any preceding claim wherein the range of products comprises at least one food product suitable for each stage of infant development.

6. A range of infant food products according to any preceding claim wherein the range of products comprises two or more food products suitable for each stage of infant development.

7. A range of infant food products according to any preceding claim wherein the range of products comprises at least a vegetable based product and a fruit based product for each stage of infant development.

8. A range of infant food products according to any preceding claim wherein the range of products comprises a plurality of vegetable based products and fruit based products for each stage of infant development.

9. A range of infant food products according to any preceding claim wherein the range of products comprises at least a vegetable based product and a fruit based product for stage 1 of infant development.

10. A range of infant food products according to any preceding claim wherein the range of products comprises at least a vegetable based product, a complete meal and a fruit based product for stage 2 of infant development.

11. A range of infant food products according to any preceding claim wherein the range of products comprises at least a vegetable based product, a complete meal and a fruit based product for stage 3 of infant development.

12. A range of infant food products according to any preceding claim wherein the range of products comprises at least a vegetable based product, a complete meal and a fruit based product for stage 4 of infant development.

13. A feeding regime for meeting the nutritional needs of an infant during different stages of development, the regime comprising administering to an infant a range of food products according to any preceding claim.

14. Use of a range of food products according to any one of claims 1 to 12 in the manufacture of one or more medicaments or functional foods for the prevention or treatment of a nutritionally related disorder.

15. A method of preventing, treating or delaying the onset of a nutritionally related disorder, comprising administering a range of food products according to any one of claims 1 to 12.

16. Use of claim 14 or the method of claim 15 wherein the nutritionally related disease is selected from obesity, malnutrition, diabetes and heart disease.

17. A range of infant food products substantially as described herein.
